(19) United States
(12) Patent Application Publication
(10) Pub. No.: US 2026/0169283 A1
(43) Pub. Date: Jun. 18, 2026

(54) LENS UNIT AND CAMERA MODULE

(71) Applicant: SOMAR CORPORATION, Tokyo (JP)

(72) Inventor: Naoki Sakazume, Tokyo (JP)

(21) Appl. No.: 18/719,376

(22) PCT Filed: Dec. 15, 2022
(86) PCT No.: PCT/JP2022/046223

§ 371 Date: Jun. 13, 2024

(30) Foreign Application Priority Data
Dec. 17, 2021 (JP) 2021-204759

(51) Int. Cl. G02B 27/00; G02B 13/00; G02B 13/18

(52) U.S. Cl. CPC G02B 27/0025; G02B 13/0035; G02B 13/004; G02B 13/0045; G02B 13/18

(57) ABSTRACT

A lens unit including a ring-shaped light-shielding member, which is effective to remove unnecessary lights entering to the lens unit of a camera module, and a camera module provided with the unit. The camera module includes the lens unit and an image pickup element for picking up an image of a subject through the lens unit. The lens unit has a group of lenses composed of lenses stacked in the direction of an optical axis X. Spacers are provided between lenses. An antireflection film is provided at least on an end surface side of at least one of substrates, which are bodies of the spacers. The antireflection film is configured by a membrane having a thickness of 2 μm or more and 40 μm or less formed from a liquid composition having a specific composition by spray coating

### TECHNICAL FIELD

The present invention relates to a lens unit and a camera module using the same.

### BACKGROUND ART

Electronic devices, such as a smartphone, tablet and digital camera, have a camera module built therein for picking up an image of a subject and converting it into an image signal. This camera module comprises an image pickup element for picking up an image of a subject and a lens unit for focusing the subject image on the image pickup element. The lens unit is normally configured by a plurality of optical lenses combined.

A camera module is required to remove an incident light and reflection light, which are unnecessary (hereinafter, also simply referred to as “unnecessary lights”) for focusing an image of a subject, to prevent arising of halation, lens flare and ghost, etc. and to improve a quality of a picked-up image. As a means therefor, in the lens unit to be used for a camera module, a ring-shaped light-shielding member for removing unnecessary lights is provided between a pair of optical lenses in a plurality of constituting optical lenses.

As a light-shielding member of this kind, what obtained by using a light-shielding film, wherein a light-shielding layer comprising carbon black, lubricant, fine particles and a binder resin is formed on both surfaces of a film substrate, and processing it into a ring shape (for example, the patent document 1) is known.

### RELATED ART DOCUMENTS

### Patent Document

Patent Document 1: WO2006/16555, publication

### SUMMARY OF THE DISCLOSED SUBJECT MATTER

When the light-shielding member of the related art above is provided between a pair of optical lenses, however, unnecessary lights are not removed sufficiently and unnecessary lights entered to a lens unit reflect on an exposed part of a film substrate (end surfaces of the film substrate with no light-shielding layer formed thereon), consequently, a flare phenomenon arose in some cases.

The present invention was made in consideration with the circumstances above. The present invention has an object thereof to provide a lens unit comprising a ring-shaped light-shielding member built therein, which is effective to remove unnecessary lights entering to a lens unit of a camera module, and a camera module comprising the unit.

The present inventors conducted studies diligently and found that when a ring-shaped light-shielding member provided between a pair of lenses of a lens unit fulfills the following requirements, it is effective to remove unnecessary lights entering to a lens unit of a camera module.
To use a liquid composition having a specific composition comprising a predetermined ratio of unevenness forming particles comprising, in a range of a predetermined mass ratio, large and small inorganic-type particles having particle diameters in predetermined ranges.
To use a liquid composition having a specific composition explained above to form a membrane having a predetermined thickness by a spray coating.

Based on these newly acquired knowledge, the present inventors completed the invention as provided below and attained the object above.

Below, (A) indicates a resin component, (B) unevenness forming particles, (B1) inorganic small particles having a particle diameter (d₁) of 0.05 μm or more and 0.4 μm or less, (B2) inorganic large particles having a particle diameter (d₂) of 2 μm or more and 6 μm or less, and (C) a diluent solvent.

According to the present invention, there is provided a lens unit, configured by providing a group of lenses, which is composed of a plurality of lenses stacked in the direction of an optical axis, in a holder,
wherein
a ring-shaped light-shielding member is provided between at least one pair of lenses;
the light-shielding member has an antireflection film at least on an end surface;
the antireflection film is configured by a membrane having a thickness of 2 μm or more and 40 μm or less formed from a liquid composition by spray coating;
the liquid composition comprises at least (A), (B) and (C);
(B) is contained in an amount of 20% by mass or more and 60% by mass or less in a total amount of 100% by mass of all solid content in the composition; and
(B) comprises (B1) and (B2) in an amount of 90% by mass or more and a mass ratio of (B2) with respect to (B1):1 is 1.8 or more and 3.3 or less.

According to the present invention, there is provided a camera module, comprising the lens unit above and an image pickup element for picking up an image of a subject through the lend unit.

According to the present invention, there is provided an antireflection film, formed on components of a lens unit, configured by a membrane having a thickness of 2 μm or more and 40 μm or less formed from a liquid composition by spray coating:
wherein
the liquid composition comprises at least (A), (B) and (C);
(B) is contained in an amount of 20% by mass or more and 60% by mass or less in a total amount of 100% by mass of all solid content in the composition; and
(B) comprises (B1) and (B2) in an amount of 90% by mass or more, and a mass ratio of (B2) with respect to (B1):1 is 1.8 or more and 3.3 or less.

As components of a lens unit, on which an antireflection film is formed, a holder for holding a group of lenses composed of a plurality of lenses and a ring-shaped light-shielding member provided between a pair of lenses in the group of lenses held in the holder, etc. may be mentioned.

Aa place to form an antireflection film on each component is an inner wall in the case of a holder for holding a group of lenses and on an end surface (an inner end surface, outer end surface or both of the inner and outer end surfaces) in the case of a ring-shaped light-shielding member.

The light composition according to the above may include the modes below.
It is preferable that (B2) includes silica.
Silica preferably contains composite silica made into black color by a colorant.
It is preferable that (B1) contains carbon black.
Viscosity at 25° C. is preferably 1 mPa·s or more and 30 mPa·s or less.

The antireflection film explained above may include the modes below.
It is preferable that an outermost surface of a plane formed with a membrane has glossiness of less than 1% against an incident light with an incident angle of 60° (hereinafter, also simply referred to as “60°-glossiness”), glossiness of less than 5% against an incident light with an incident angle of 85° (hereinafter, also simply referred to as “85°-glossiness”), reflectance of 4% or less against a light having a wavelength of 550 nm (hereinafter, also simply referred to as “reflectance”), an L value in CIELAB color system by SCE method of 22 or less and an optical density of 1.0 or more.
On an outermost surface of a plane formed with a membrane, it is preferable that a maximum height Rz (hereinafter, also simply referred to as “Rz”) based on JIS B0601:2001 is 7 μm or more, an average length Rsm of contour curve elements (hereinafter, also simply referred to as “Rsm”) is 80 μm or more, a skewness Rsk of a contour curve (hereinafter, also simply referred to as “Rsk”) is 0.3 or less, and Kurtosis Rku of a contour curve (hereinafter, also simply referred to as “Rku”) is 3 or more.

According to the present invention, there is provided a lens unit incorporating a ring-shaped light shielding member, which is effective to remove unnecessary lights entering to the lens unit in a camera module, and a camera module comprising the unit.

### BRIEF DESCRIPTION OF DRAWINGS

FIG. 1 is a disassembled perspective view schematically showing a lens unit and a camera module according to one mode of a present invention.

FIG. 2(a) is a plan view showing a lens spacer, as an example of a ring-shaped light shielding member as a component of the lens unit shown in FIG. 1, and FIG. 2(b) is a sectional view along a line IIb-IIb in FIG. 2(a).

### EXEMPLARY MODE FOR CARRYING OUT THE DISCLOSED SUBJECT MATTER

Below, the best modes for carrying out the invention will be explained, however, the present invention is not limited to the modes below and also includes those obtained by suitably modifying or improving the modes explained below based on ordinary knowledge of persons skilled in the art within the scope of the present invention.

As to a range of value in the present specification, an upper limit value or a lower limit value described in certain value ranges may be replaced by values indicated in the examples.

In the present specification, when there are a plurality of kinds of substances falling under each component in a composition, a content ratio or a content in each component in the composition indicates a content ratio or a content of a total of the plurality of kinds of substances being in the composition unless otherwise mentioned.

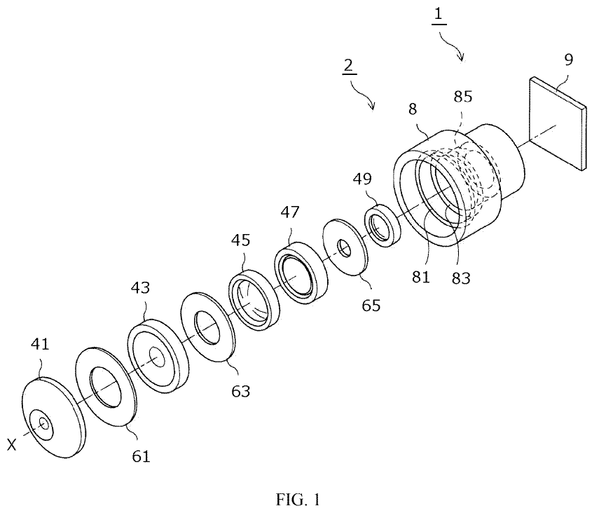

As shown in FIG. 1, a camera module 1 according to one mode of the present invention comprises a lens unit 2. The lens unit 2 comprises a group of lenses composed of five lenses 41, 43, 45, 47 and 49 stacked in the direction of an optical axis X. The number of lenses to compose the group of lenses is not limited to 5. In this example, among five lenses 41, 43, 45, 47, and 49, spacers 61, 63 and 65 are provided, which are ring-shaped light-shielding members, between three pairs of lenses (lenses 41 and 43, lenses 43 and 45, and lenses 47 and 49) and the spacers form a group of spacers. Both of the group of lenses and the group of spacers are placed in a cylindrical holder having multiple steps (a barrel) 8 configured by a resin or metal, etc. The holder 8 of the present example is provided with three step parts 81, 83 and 85 on the inner circumferential part, and the group of lenses and group of spacers are held and arranged at predetermined positions in the holder 8 in a state of being arranged and stacked on the same optical axis by using the step parts 81, 83 and 85. A various kinds of lenses (convex lens and concave lens, etc.) may be used as the lenses 41, 43, 45, 47 and 49. It does not matter if the curved surface may be spherical or aspherical and if a material thereof is a resin (for example, (a cyclic olefin-type resin, COC and COP), a polycarbonate-type resin, a liquid crystal polymer, etc.) or glass.

The camera module 1 comprises an image pickup element 9 together with the lens unit 2. The image pickup element 9 is arranged on an optical axis of the lens unit 2 and is configured by a CCD image sensor or a CMOS image sensor, etc.

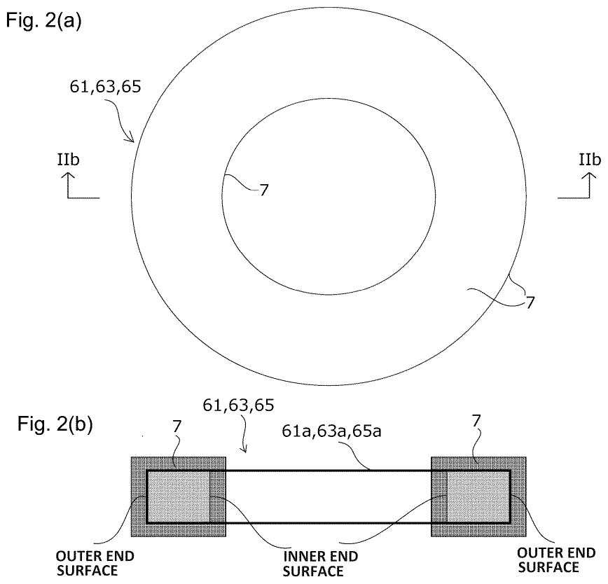

The spacers 61, 63 and 65 have a circular shape (a ring shape) in a plan view and have a shape having a cylindrical hollow portion at the center part in a sectional view. As shown in FIG. 2(a) and FIG. 2(b), the spacers 61, 63 and 65 all have a spacer substrate (hereinafter, also simply referred to as “a substrate”) having an approximately the same shape with themselves.

The substrates 61a, 63a and 65a are configured by a resin film, etc. As a resin film, for example, a polyester film, polyimide film, polystyrene film, etc., polycarbonate-type film, acrylic-type film, nylon-type film, polyamide-type film, polyolefin-type film, cellulose-type film, polysulfone-type film, polyphenylene sulfide-type film, polyether sulfone-type film, polyether ether ketone-type film, etc. may be mentioned.

The substrates 61a, 63a and 65a may contain a pigment. A pigment able to be contained is not particularly limited, and either of resin-type particles and inorganic-type particles may be used in the same way as in (B1) and (B2). As a resin-type particle, for example, a melamine resin, benzoguanamine resin, benzoguanamine/melamine/formalin condensate, acrylic resin, urethane resin, styrene resin, fluoric resin and silicone resin, etc. may be mentioned. As an inorganic particle, silica, alumina, calcium carbonate, barium sulfate, titanium oxide, magnetite-type black, copper/iron/manganese-type black, titanium black, carbon black and aniline black, etc. may be mentioned. These pigments may be used alone or in combination of two or more to use.

A content ratio of the pigment, when contained in the substrates 61a, 63a and 65a, may be set arbitrarily in accordance with a required performance, etc. and is not particularly limited. It is, for example, 0.3% by mass or more, preferably 0.4% by mass or more and 15% by mass or less and preferably 12% by mass or less or so with respect to the substrates 61a, 63a and 65a.

A thickness of the substrates 61a, 63a and 65a is not particularly limited, however, in terms of reducing weight and thickness thereof, it is, for example, 3 μm or more, preferably 4 μm or more and, for example, 150 μm or less and preferably 140 μm or less or so. In the case of a use purpose requiring a particularly thinned membrane, a thickness of the substrates 61a, 63a and 65a is preferably 3 μm or more, more preferably 5 μm or more, and preferably 50 μm or less, more preferably 25 μm or less, and furthermore preferably 15 μm or less.

### (Antireflection Film)

An antireflection film 7 is provided on at least an end surface side of at least one of the substrates 61a, 63a and 65a. As it is “at least one of the substrates 61a, 63a and 65a”, an antireflection film 7 may be formed on any one of the substrates 61a, 63a and 65a, on two of them or on all of them. “An end surface” includes an inner end surface and outer end surface. Since it is “on an end surface side”, in addition to the mode of forming an antireflection film 7 directly on at least one end surface (an inner end surface, outer end surface or both on the inner and outer end surfaces) of the substrates 61a, 63a and 65a, a mode of providing an optional layer (for example, a primer layer, etc.) between a substrate and an antireflection film 7 before forming is included.

In addition to an end surface side, an antireflection film 7 may be provided on at least one of main surfaces (a front surface, back surface or both of the front and back surfaces) of at least one of the substrates 61a, 63a and 65a. FIG. 2(a) and FIG. 2(b) show as an example the case of forming an antireflection film 7 directly on both of the inner and outer end surfaces and both main surfaces (front surface and back surface) of the substrates 61a, 63a and 65a.

A role of the antireflection film 7 is as below. Among lights entered from a subject side of the lens unit 2, a light not hitting end surfaces of spacers 61, 63 and 65 (effective ray, let's call it “an incident light a” here) passes through a lens unit 2 and enters an image pickup element 9. On the other hand, among the lights entered to the lens unit 2, a light reached to end surfaces of spacers 61, 63 and 65 (unnecessary lights, let's call it “an incident light b”) hits the antireflection film 7 formed on the substrates 61a, 63a and 65a. When an antireflection film 7 is not formed on the substrates 61a, 63a and 65a, a light reached to end surfaces of the substrates 61a, 63a and 65a is surface-reflected and enters to the image pickup element 9 as an inner reflection light, which is not directly related to an image. The inner surface reflection light causes flare and ghost, which are elements to deteriorate the image. On the other hand, as in one mode, when an antireflection film 7 is formed on the substrates 61a, 63a and 65a, it is possible to reduce an inner surface reflection of an incident light b, which is an unnecessary light, entering obliquely to the lens unit 2. Consequently, an inner surface reflection light adversely affecting the image is reduced, so that arising of flare and ghost can be prevented.

The antireflection film 7 of the present example is configured by a membrane formed from a liquid composition.

### <Liquid Composition>

A liquid composition according to one mode (hereinafter, also simply referred to as “a composition”) is used for forming a membrane on at least an end surface and furthermore on at least one main surface side of at least one of the substrates 61a, 63a and 65a (hereinafter, also simply referred to as “an object to be coated”) and comprises (A) a resin component, (B) unevenness forming particles and (C) a diluent solvent. The (B) used for forming a composition comprises (B1) small particles having a particle diameter (d₁) of 0.05 μm or more and 0.4 μm or less and (B2) large particles having a particle diameter (d₂) of 2 μm or more and 6 μm or less, and it may also comprise components other than (B1) and (B2). Namely, a composition according to one mode is configured by comprising (A), (B1), (B2) and (C). A composition according to one mode may be used suitably by spray coating when applying to a surface of an object to be coated.

### —(A)—

The (A) to be used for forming a composition serves as a binder of (B). A material of (A) is not particularly limited and either of a thermoplastic resin and thermosetting resin may be used. As a thermosetting resin, for example, an acrylic-type resin, urethane-type resin, phenol-type resin, melamine-type resin, urea-type resin, diallyl phthalate-type resin, unsaturated polyester-type resin, epoxy-type resin and alkyd-type resin, etc. may be mentioned. As a thermoplastic resin, a polyacrylic ester resin, polyvinyl chloride resin, butyral resin and styrene-butadiene copolymer resin, etc. may be mentioned. In terms of heat resistance, moisture resistance, solvent resistance and surface hardness of an uneven membrane to be formed, a thermosetting resin is preferably used as (A). As a thermosetting resin, when considering flexibility and strength of a membrane to be formed, an acrylic resin is particularly preferable. As (A), one kind may be used alone or two or more kinds may be combined for use.

A content (a total amount) of (A) is not particularly limited, however, when considering a blending balance with other components, it is preferably 5% by mass or more, more preferably 15% by mass or more, furthermore preferably 25% by mass or more and preferably 50% by mass or less, more preferably 45% by mass or less and furthermore preferably 40% by mass or less with respect to a total amount (100% by mass) of total solid content in the composition.

### —(B)—

It is essential that the (B) to be used for forming a composition comprises a plurality of unevenness forming particles having different sizes in combination. Particularly, (B1) small particles and (B2) large particles are combined to be used as (B). For example, in the case of composing (B) only of two kinds of unevenness forming particles having different sizes (namely, (B1) and (B2)), a particle diameter (d₂) of (B2) is preferably 10 times or more, more preferably 15 times or more a particle diameter (d₁) of (B1) and preferably 40 times or less and more preferably 35 times or less. When using as (B) three or more kinds of unevenness forming particles having different sizes, a particle diameter (dₘₐₓ) of unevenness forming particles with a maximum particle diameter and a particle diameter (dₘᵢₙ) of unevenness forming particles with a minimum particle diameter may be adjusted to have the relationship above (namely, (dₘₐₓ) is preferably 10 times or more, more preferably 15 times or more the size of (dₘᵢₙ) and preferably 40 times or less and more preferably 35 times or less the size of (dₘᵢₙ)).

In one mode, (d₁) is preferably 0.05 μm or more, more preferably 0.1 μm or more and preferably 0.4 μm or less and more preferably 0.3 μm or less. (d₂) is preferably 2 μm or more, more preferably 3 μm or more and preferably 6 μm or less, more preferably 5 μm or less and furthermore preferably 4 μm or less.

A particle diameter (d₁) of (B1) and a particle diameter (d₂) of (B2) are a median diameter based on volume measured by a laser diffraction/scattering particle size distribution measuring apparatus.

In one mode, a mass ratio of (B2) in (B) is, with respect to (B1):1, preferably exceeding 1.75, more preferably 1.8 or more and preferably less than 3.58 and more preferably 3.3 or less. The present inventors found that by using (B1) and (B2) having the specific ranges of particle diameters as explained above combined in a range of this mass ratio, one particle (B1) is easily buried between adjacent two particles (B2) in a membrane to be formed. As a result, low glossiness and low reflectivity on the membrane surface can be realized and a blackness degree can be increased (an L value becomes low).

A total content (total amount) of (B1) and (B2) in (B) is preferably 90% by mass or more and more preferably 95% by mass or more. An upper limit thereof is not particularly limited and is 100% by mass. Namely, in one mode, (B1) and (B2) may be contained preferably 90% by mass or more in 100% by mass of (B).

A content (total amount) of (B) with respect to a total amount (100% by mass) of a total solid content in the composition is preferably 20% by mass or more, more preferably 25% by mass or more, furthermore preferably 30% by mass or more and preferably 60% by mass or less, more preferably 50% by mass or less, furthermore preferably 45% by mass or less and particularly preferably 40% by mass or less. When a total amount of (B) is less than 20% by mass, disadvantages of an increase of glossiness and optical density shortage are caused, while when exceeding 60% by mass, (A) in a formed coating film is decreased relatively, which results in a disadvantage that a coating film falls off from an object to be coated in some cases.

As (B2), either of resin-type particles and inorganic-type particles may be used. As resin-type particles, for example, a melamine resin, bunzoguanamine resin, benzoguanamine/melamine/formalin condensate, acrylic resin, urethane resin, styrene resin, fluoric resin and silicon resin, etc. may be mentioned. As inorganic-type particles, silica, alumina, calcium carbonate, barium sulfate, titan oxide and carbon, etc. may be mentioned. They may be used alone or in combination of two or more kinds.

To obtain more excellent characteristics, it is preferable to use inorganic-type particles as (B2). By using inorganic-type particles as (B2), a lower glossy and high light-shielding membrane can be formed easily. As inorganic-type particles to be used as (B2), silica is preferable. A shape of (B2) is not particularly limited but it is preferable to use particles having a narrow particle distribution (having a CV (Coefficient of Variation) value of, for example, 15 or less) (a sharp product) to realize lower glossiness, lower reflectance and a lower L value on a membrane surface to be formed. The CV value is a numerically expressed degree of spread of a particle diameter distribution (variation of particle diameters) with respect to an average value of a particle diameter (calculated average particle diameter). When using a particle as above, a chance of contacting between (B2) and (B1) increases in a membrane to be formed so as to realize furthermore lower glossiness, lower reflectance and a lower L value on the membrane surface.

Also, in order to decrease glossiness on the membrane surface to be formed, a particle in indefinite form is preferably used as (B2). It is particularly preferable to use a porous indefinite-shaped silica particle as (B2). When using particles as above as (B2), lights refract repeatedly on a surface and inside when formed into a membrane, consequently, a glossiness on the membrane surface can be furthermore reduced.

In one mode, in order to suppress reflection of lights on a surface of a membrane to be formed, (B2) may be colored black by using an organic-type or inorganic-type colorant. As a material therefor, composite silica, conductive silica and black silica, etc. may be mentioned.

As composite silica, for example, what obtained by synthesizing carbon black (hereinafter, also simply referred to as “CB”) and silica at a nano level and composing may be mentioned. As conductive silica, for example, what obtained by coating silica particles with conductive particles, such as CB, may be mentioned. As black silica, for example, natural ore containing graphite in silica may be mentioned.

As well as (B2), a material of (B1) is not particularly limited and either of resin-type particles and inorganic-type particles may be used. As resin-type particles, for example, a melamine resin, bunzoguanamine resin, benzoguanamine/melamine/formalin condensate, acrylic resin, urethane resin, styrene resin, fluoric resin and silicon resin, etc. may be mentioned. As inorganic-type particles, silica, alumina, calcium carbonate, barium sulfate, titan oxide and CB, etc. may be mentioned. They may be used alone or in combination of two or more kinds.

As (B1), for example, CB, etc. added as a colorant/conductive agent may be also used. When using CB as (B1), a membrane to be formed is colored, so that an effect of preventing reflection is increased furthermore and a preferable antistatic effect can be obtained.

### —(C)—

The (C) used for forming a composition is contained for the purpose of dissolving (A) and adjusting viscosity of the whole composition. When using (C), (A) and other component to be added in accordance with need can be mixed more easily and uniformity of the composition is improved. Also, viscosity of the composition can be adjusted properly, so that, when forming a membrane on a surface of an object to be coated, operability of the composition and uniformity of an application thickness can be improved.

As (C), it is not particularly limited as long as it is a solvent capable of dissolving (A), and an organic solvent or water may be mentioned. As an organic solvent, for example, methylethylketone, toluene, propylene glycol monomethyl ether acetate, ethyl acetate, butyl acetate, methanol, ethanol, isopropyl alcohol and butanol, etc. may be used. The (C) may be used alone or in combination of two or more kinds.

A content (total amount) of (C) in a composition is, with respect to 100 parts by mass of (A), preferably 1 part by mass or more, more preferably 3 parts by mass or more and preferably 20 parts by mass or less in order to obtain the effects of containing (C) as explained above.

### —(D) Optional Component—

Other than the components ((A), (B) and (C)) above, the composition may contain (D) to an extent of not hindering the effects of the present invention. As (D), for example, a leveling agent, thickener, pH adjusting agent, lubricant, dispersant, defoaming agent, curing agent and reaction catalyst, etc. may be mentioned.

Particularly when using a thermosetting resin as (A), crosslinking of (A) can be accelerated by blending a curing agent. As a curing agent, a urea compound having a functional group, a melamine compound, isocyanate compound, epoxy compound, aziridine compound and oxazoline compound, etc. may be mentioned. As a curing agent, isocyanate compound is preferable among them. The curing agent may be used alone or in combination of two or more kinds.

A ratio of blending a curing agent in a composition is, with respect to 100 parts by mass of (A), preferably 10 parts by mass or more and 80 parts by mass or less. When adding a curing agent in this range, hardness of a membrane to be formed is enhanced, consequently, characteristics of the membrane surface can be maintained for a long term even when the membrane is exposed to an environment of rubbing against other member, and low glossiness, a high light-shielding characteristic, low reflectance and a high degree of blackness can be maintained easily.

When a curing agent is contained in a composition, a reaction catalyst may be used together so as to accelerate reaction of the curing agent with (A). As a reaction catalyst, for example, ammonia and aluminum chloride, etc. may be mentioned. A ratio of a reaction catalyst to be contained in the composition is, with respect to 100 parts by mass of a curing agent, preferably 0.1 part by mass or more and 10 parts by mass or less.

A composition according to one mode has viscosity at 25° C. of preferably 1 mPa·s or more, preferably 30 mPa·s or less and more preferably 20 mPa·s or less for the reason of coating by using a spray (spray coating) while maintaining smoothness of the composition on a surface of an object to be coated. When viscosity of the composition is too low, there is a possibility in some cases that a membrane having a thickness enough to remove unnecessary lights. When viscosity of the composition is too high, it becomes difficult to spray the composition uniformly on a surface of an object to be coated, so that there is a possibility that a membrane having a uniform thickness with little performance variation cannot be obtained in some cases.

The viscosity above differs depending on components contained in the composition, that is, kinds and molecular weights, etc. of (A) and (B) to be used. Also, when blending (D) in addition to the (A) and (B) above, it differs depending on a kind and molecular weight, etc. of (D). However, it can be adjusted easily by adjusting an amount of (C) in the composition in the range stated above.

A composition according to one mode of the present invention may be prepared (produced) by adding (A), (B) and, when needed, (D) to (C), and mixing and agitating. An order of mixing the respective components is not particularly limited as long as the components are mixed uniformly.

A composition according to one mode of the present invention may be one-liquid type or two-liquid type. When containing a curing agent as (D) in the composition, the composition according to one mode may be two-liquid type with, for example, a first liquid comprising components other than a curing agent and a second liquid comprising a curing agent.

A method of forming a membrane is not particularly limited. A membrane may be formed on an object to be coated by any method or by an apparatus, for example, spray coating (for example, air spray, airless spray and electrostatic spray, etc.), paint brush, curtain flow coating, roller brush coating, bar coating, kiss roll, metaling bar, gravure roll, reverse roll, dip coating and die coating, etc. may be used.

Particularly, a composition according to one mode preferably forms a membrane by using spray coating, which requires spray of droplets from a small spray hole. In other words, a membrane according to one mode is formed from a liquid composition and a membrane to be formed is a spray coated membrane.

According to spray coating using a composition according to one mode, droplets of the composition adhere successively to a surface of an object to be coated and, at the same time, volatilization of (C) in the droplets adhered to the object to be coated proceeds. As a result, a solid content (particles) obtained by removing (C) from droplets laminates successively on the surface of the object to be coated so as to form a solid particle laminate. According to one mode, this solid particle laminate configures a membrane.

In the case of using a composition comprising a thermosetting resin as (A) and furthermore comprising a curable agent as (D), it is preferable that after a solid particle laminate is applied to a surface of an object to be coated, the laminate is heated to be cured. Here, even if a trace of (C) remains in the preheated laminate, it volatilizes almost completely by the heating.

Heating condition may be adjusted properly depending on a thickness of the preheat laminate, heat resistant characteristic of an object to be coated, and a kind of (C) to be used, etc. The heating condition is, for example, at 70° C. or more and 150° C. or less for one minute or more and 10 minutes or less, and preferably at 100° C. or more and 130° C. or less for 2 minutes or more and 5 minutes or less.

A thickness of antireflection film 7 is not particularly limited as long as their strength in adhesiveness to substrates 61a, 63a and 65a is preferable, inner surface reflection on a surface formed with the membrane is suppressed, and arising of flare or ghost due to inner surface reflection lights, on which the membrane is formed, can be suppressed. To raise an example of a preferable film thickness, it is preferably 2 μm or more, more preferably 5 μm or more and preferably 40 μm or less and more preferably 25 μm or less.

Note that a thickness of the antireflection film 7 is a height including parts protruding, due to (B2) and (B1) in the membrane, from a surface of an object to be coated. The film thickness can be measured by a method based on JIS K7130.

### <Characteristics of Membrane>

Characteristics of a membrane formed from a composition according to one mode are as below.

(Glossiness, Reflectance, Optical Density, L value and Adhesiveness)

A membrane formed from a composition according to one mode preferably has 60°-glossiness of less than 1%, 85°-glossiness of less than 5%, reflectance of 4% or less, an L value of 22 or less and an optical density of 1.0 or more.

Here, when configured that a membrane formed from a composition according to one mode is exposed as an outermost surface, 60°-glossiness, 85°-glossiness, reflectance, an L value and optical density on a real surface of the membrane are preferably in the ranges as above. When another membrane is coated on a membrane formed from a composition according to one mode, 60°-glossiness, 85°-glossiness, reflectance, an L value and optical density on a surface of this another membrane (that is, an outermost surface of the light shielding member) are preferably in the ranges as above. Hereinafter, these surfaces will be referred to as “an outermost surface of a membrane”.

An outermost surface of a membrane formed from a composition according to one mode preferably has 60°-glossiness of less than 1%, 85°-glossiness of less than 5%, reflectance 4% or less, an L value 22 or less and an optical density 1.0 or more. When 60°-glossiness, 85°-glossiness, reflectance, an L value and optical density on an outermost surface of a membrane are in the ranges as above, it is possible to attain low glossiness, low reflectance (an excellent antireflection property: It will be the same below.), a high blackness degree and a high light-shielding characteristic on the outermost surface of the membrane.

The upper limit value of 60°-glossiness is more preferably less than 0.8% and furthermore preferably less than 0.5%. When 60°-glossiness is adjusted to be in the range above, flare and ghost phenomenon can be prevented effectively. A lower limit value of 60°-glossiness is not particularly limited, and the lower the better.

The upper limit value of 85°-glossiness is more preferably less than 3.5% and furthermore preferably less than 2.5%. When 85°-glossiness is adjusted to be in the range above, advantages of preventing flare and ghost phenomenon and termination of angle dependency can be obtained more easily. A lower limit value of 85°-glossiness is not particularly limited, and the lower the better.

An upper limit value of reflectance is more preferably 3% or less and furthermore preferably 2.5% or less. A lower limit value of reflectance is not particularly limited. The lower the reflectance is, the better. When reflectance is adjusted to be in the range above, it is possible to prevent flare and ghost phenomenon due to diffuse reflection (inner surface reflections) more effectively.

A lower limit value of an optical density is more preferably 1.8 or more and furthermore preferably 2.0 or more. When an optical density is adjusted to be in the range above, a light-shielding characteristic can be improved furthermore. An upper limit value of an optical density is not particularly limited. The higher, the better. For example, it is less than 3.0.

An upper limit value of an L value (a blackness degree) is more preferably 20 or less and furthermore preferably 18 or less. The lower limit value thereof is not particularly limited. In terms of demands for more blackness of the appearance, the lower the L value is, the better. When the L value is adjusted to be in the range above, it becomes possible to increase blackness and to emphasize blackness.

The L value above is a lightness L*value on an outermost surface of a membrane, which is in CIE 1976 L*a*b*(CIELAB) color space system based on a SCE method. The SCE method is a specularly reflected light removal method, which means a method of measuring color by removing specularly reflected lights. Definition of the SCE method is defined in JIS Z8722 (2009). Since specularly reflected lights are removed in the SCE method, the color is close to the color actually viewed by human.

CIE is abbreviation of Commission Internationale de l'Eclairage, which means international committee on illumination. The CIELAB color space was adopted in 1976 in order to measure color difference between perception and devices and is a uniform color space defined in JIS Z 8781 (2013). Three coordinates in CIELAB are indicated by L*value, a*value and b*value. The L*value indicates lightness and expressed from 0 to 100. When L*value is 0, it indicates black, while it indicates white diffusion color when L*value is 100. The a*value indicates colors between red and green. When a*value is in minus, it indicates colors close to green, while when in plus, it indicates colors close to red. The b*value indicates colors between yellow and blue. When b*value is in minus, it indicates colors close to blue, while it indicates colors close to yellow when in plus.

A lower limit value of an optical density is more preferably 1.5 or more and furthermore preferably 2.0 or more. When an optical density is adjusted to be in the range above, a light-shielding characteristic can be enhanced furthermore. An upper limit value of optical density is not particularly limited, and the higher the better.

The glossiness, reflectance, an L value and optical density explained above can be measured by methods explained later on.

In addition to the characteristics (glossiness, reflectance, an L value and optical density) above, the membrane preferably has good adhesiveness to a surface of an object to be coated. Adhesiveness of a membrane formed from a composition to a surface of an object to be coated is, as explained in adhesiveness evaluation in later-explained examples, that preferably 75% or more of the coating remain.

### (Rz, Rsm, Rsk, Rku and Ra)

In a membrane formed from a composition according to one mode, it is preferable that a maximum height Rz is 7 μm or more, an average length Rsm of contour curve element is 80 μm or more, skewness Rsk of contour curve is 0.3 or less and Kurtosis Rku of a contour curve is 3 or more on its outermost surface of the membrane. When Rz, Rsm, Rsk and Rku on the outermost surface of the membrane are in the ranges above, glossiness, reflectance, an L value, and optical density on the outermost surface of a membrane can become in the ranges above (60°-glossiness of less than 1%, 85°-glossiness less than 5%, reflectance 4% or less, an L value 22 or less, and optical density 1.0 or more), consequently, low glossiness, low reflectance, high blackness degree and a high light-shielding characteristic on the outermost surface of a membrane can be attained.

The lower limit value of Rz is more preferably 10 μm or more. When the lower limit value of Rz is as above, low glossiness, low reflectance and a high light-shielding characteristic can be adjusted furthermore easily.

An upper limit value of Rz is not particularly limited but is preferably 50 μm or less and more preferably 30 μm or less. When an upper limit value of Rz is as above, furthermore lower glossiness, lower reflectance, higher blackness and a higher light-shielding characteristic on the outermost surface of a membrane can be attained easily.

The Rsm indicates an average length of contour curve elements within the standard length. A lower limit value of Rsm is more preferably 100 μm or more and furthermore preferably 120 μm or more. When a lower limit value of Rsm is as above, an advantage of low glossiness can be attained furthermore easily. An upper limit value of Rsm is not particularly limited, but preferably 160 μm or less. In this range, furthermore excellent adhesiveness between an object to be coated and a membrane to be formed thereon can be obtained.

The Rsk is an average of the cubes of a height Z(x) in a dimentionless reference length obtained by a root mean square height (Zq) cubed, which is an index indicating deviation from an average line of uneven shape, that is, a degree of strain on an outermost surface of a membrane. There is a tendency that when Rsk value is in plus (Rsk>0), the uneven shape is deviated to the concave side, so that protruding shape becomes sharp. On the other hand, when in minus (Rsk<0), the uneven shape is deviated to the convex side, so that protruding shape becomes dull. When the protruding shape of contour curve is dull, haze becomes low comparing with the case with a sharp shape.

An upper limit value of Rsk is more preferably 0.2 or less. When an upper limit value of Rsk is as above, an advantage of low glossiness can be obtained furthermore easily. A lower limit value of Rsk is not particularly limited but is preferably 0 or more. When a lower limit value of Rsk is as above, an advantage of low glossiness can be obtained easily.

The Rku indicates an average of the fourth-power of a height Z(x) in a dimentionless reference length obtained by the four-power of a root-mean-square height (Zq), and is an index indicating a degree of sharpness at tips of unevenness on an outermost surface of a membrane. When Rku is larger, there are more sharp tips on unevenness, so that an inclined angle close to tips of unevenness becomes larger while inclined angles of other parts become smaller, so that reflection of background tends to arise.

A lower limit value of Rku is more preferably 3.3 or more. When a lower limit value of Rku is as above, an advantage of low glossiness can be obtained more easily. An upper limit value of Rku is not particularly limited, but is preferably 5 or less. When an upper limit value of Rku is as above, an advantage of low glossiness can be obtained more easily.

In a membrane formed from a composition according to one mode, an arithmetic average roughness (Ra) on an outermost surface is preferably 0.5 μm or more, more preferably 1.0 μm or more and furthermore preferably 1.5 μm or more.

Those Rz, Rsm, Rsk, Rku and Ra on an outermost surface of a membrane as explained above can be measured or calculated based on JIS B0601:2001.

### (Other Modes)

An antireflection film 7 according to one mode explained above may be formed directly at least on an end surface side of at least one of the substrates 61a, 63a and 65a without any pretreatment or may be formed via a primer layer, however, it is not limited to the modes. For example, it may be a mode of preparing a sheet of an antireflection film obtained by forming an antireflection film 7 by spray coating on an extremely thin plastic film (PET film, etc.), cutting the sheet to fit a shape of an end surface of at least one of the substrates 61a, 63a and 65a so as to obtain a sheet piece, then, applying the sheet piece to an end surface side of at least one of the substrates 61a, 63a and 65a via an adhesive layer and, finally, forming an antireflection film 7.

An antireflection film 7 according to one mode above is not limited to the case of forming on the ring-shaped light-shielding member (at least one of spacers 61, 63 and 65) and it may be formed on other components besides the lens unit 2, for example, on an inner wall (the side provided with the step portions 81, 83 and 85) of the holder 8.

### EXAMPLES

Below, the present invention will be explained specifically based on examples (including modes and comparative examples), however, the present invention is not limited to the examples. Below, “part” indicates “part by mass” and “%” indicates “% by mass”.

### [Components of Composition]

As A (a resin component), a substance below was prepared.
A1: thermosetting acrylic resin
(ACRYDIC A-801 produced by DIC, solid content 50%)

As B1 (small particles) falling under B (unevenness forming particles), substances below were prepared.
B1a: carbon black (CB) (particle diameter 150 nm)
(MHI Black_#273 produced by MIKUNI Color Ltd., CB content 9.5%)·
B1b: transparent silica (particle diameter 58 nm)
(ACEMATT R972 produced by EVONIK)

As B2 (large particles) falling under B, substances below were prepared.
B2a: composite silica (particle diameter 3 μm)
(BECSIA ID produced by Fuji Silysia Chemical Ltd.)
B2b: black acrylic beads (particle diameter 3 μm)
(RUBCOULEUR 224SMD black produced by Dainichiseika Color & Chemicals Mfg Co., Ltd.)
B2c: transparent silica (particle diameter 4.1 μm)
(SYLYSIA 430 produced by Fuji Silysia Chemical Ltd.)
B2d: transparent silica (particle diameter 8 μm)
(SYLYSIA 450 produced by Fuji Silysia Chemical Ltd.)
B2e: transparent acrylic beads (particle diameter 3 μm)
(ENEOS Uni-Powder NMB-0320C produced by ENEOS Corporation)

Note that BECSIA ID used as B2a (composite silica) is composite particles of CB and silica, wherein CB/silica=about 25/75 (mass ratio). The MHI black #273 used as B1a (CB) is a CB dispersant and, in a solid content total amount 18% of the dispersant, 9.5% is CB and remaining 8.5% is other compounds. In the 8.5% of remaining compounds, 3% is a copper compound and 5.5% is an acrylic resin.

As D (optional component), a substance below was prepared.
D1: isocyanate compound
(TAKENATE D110N produced by Mitsui Chemicals, Inc., solid content 75%)

### [Object to be Coated]

As an object to be coated, sample substrates for evaluation were prepared. As a sample substrate for evaluation, a black polycarbonate sheet material was used and rectangular-shaped polycarbonate plates (100 mm in the longitudinal length, 50 mm in width and 1.5 mm in thickness) produced to be matte finish on both surfaces of the plate in the thickness (X) direction were used.

### Examples 1 to 17

### 1. Preparation of Composition

Respective components for each example with each solid content ratio shown in Table 1 were prepared, so that a total solid content becomes approximately 25% by mass, and added to a necessary amount of (C) a diluent solvent, which is a mixed solvent (methylethyl ketone:butyl acetate=50:50), and agitated to mix, and a liquid composition (hereinafter, also simply referred to as “a liquid”) was prepared.

### 2. Production of Sample for Evaluation

Each liquid obtained for each of the examples was sprayed toward an outer surface of an object to be coated by spray coating in the same method as explained in (3-1) Coating Performance below. Then, the resultant was heated at 120° C. for 3 minutes to dry, a solid particle laminate was formed by spray coating and heated to be a coating (hereinafter, also simply referred to as “a coating”) having an average membrane thickness of 20 μm on a surface of the object to be coated, so that a sample for evaluation was obtained.

### 3. Evaluation

On each liquid obtained in each of the examples, a variety of characteristics (coating performance) were evaluated in the methods explained below (liquid evaluation). Also, a coating formed on each sample for evaluation obtained in each of the examples was evaluated on a variety of characteristics (characteristics and surface properties) (sample evaluation). The results are shown in Table 1.

### [Liquid Evaluation]

### (3-1) Coating Performance

Coating performance of a liquid was evaluated by observing coating uniformity after spray coating.

An air spray configured by attaching an air brush (Spray-Work HG Single Airbrush produced by TAMIYA, Inc.) to an air can (Spray-Work Air Can 420D produced by TAMIYA, Inc.) was prepared and each liquid was poured into it. Then, the liquid was sprayed toward an outer surface of an object to be coated for 10 seconds from a 10 cm distance from a tip of the air brush, and a formed solid particle laminate was evaluated on its coating uniformity visually. Evaluation reference is as below.
◯: Lack of coating uniformity (lack of uniformity in thickness) was not observed.
Δ: Lack of coating uniformity was observed partially.
X: Lack of coating uniformity was observed in many areas.

### [Sample Evaluation]

### (3-2) Characteristics

### —Glossiness—

Glossiness against a measurement light having an incident angle of 60° (specular glossiness at) 60° and a measurement light having an incident angle of 85° (specular glossiness at) 85° on a surface of a coating formed on each sample for evaluation were measured on 9 spots by using a glossmeter (VG 7000 produced by NIPPON DENSHOKU Industries Co., Ltd.) by the method based on JIS Z8741, and an average value thereof was adopted as a glossiness degree. Evaluation reference is as below.

### (60°-Specular Glossiness)

⊚: less than 0.8% (very excellent)
◯: 0.8% or more but less than 1% (excellent)
X: 1% or more (insufficient)

### (85°-Specular Glossiness)

⊚: less than 3.5% (very excellent)
◯: 3.5% or more but less than 5% (excellent)
X: 5% or more (insufficient)

### (Comprehensive Evaluation of Glossiness)

⊚: The respective evaluations on 60°-specular glossiness and 85°-specular glossiness were all ⊚. (extremely preferable glossiness)
◯: At least one of the respective evaluations on 60°-specular glossiness and 85°-specular glossiness was ◯ and none of them was X. (extremely preferable glossiness)
X: At least one of the respective evaluations on 60°-specular glossiness and 85°-specular glossiness was X. (not low enough glossiness)

### —Reflectance—

Reflectance against lights having a wavelength of 400 nm to 700 nm on a surface of a coating formed on each of the samples for evaluation was measured at 9 spots at an interval of 1 nm by using a spectral colorimeter (CM-5 produced by Konica Minolta Inc.) by the method based on JIS Z8722, and an average value thereof was adopted as reflectance. Evaluation reference is as below.
⊚: Reflectance was 3% or less. (extremely preferable low reflectance)
◯: Reflectance exceeded 3% but 4% or less. (preferable low reflectance)
X: Reflectance exceeded 4%. (not low enough reflectance)

### —BlacknessDegree—

A degree of blackness on a surface of a coating formed on each sample for evaluation was evaluated by measuring lightness L*value in CIE 1976 L*a*b*(CIELAB) color space system on the surface by the SCE method. The lightness L*value was measured by using a spectral colorimeter (CM-5 produced by Konica Minolta Inc.) by the method based on JIS Z8781-4:2013. Evaluation reference is as below.

When measuring, a CIE standard light source D65 was used as a light source and L* value in the CIELAB color space system was obtained at a viewing angle of 10° by the SCE method. The CIE standard light source D65 is defined in JIS Z8720 (2000) “Standard Illuminants and Sources for Colorimetry”, and ISO 10526 (2007) also shows the same definition. The CIE standard light source D65 is used in the case of displaying colors of an object illuminated by daylight. A viewing angle of 10° is defined in JIS Z8723 (2009) “Methods of Visual Comparison for Surface Colours”, and ISO/DIS 3668 also shows the same definition.
⊚: An L value was 20 or less. (extremely high degree of blackness)
◯: An L value exceeded 20 but 22 or less. (high degree of blackness)
X: An L value exceeded 22. (insufficient degree of blackness)

### —Light-Shielding Characteristic—

A light-shielding characteristic of a coating formed on each of the samples for evaluation was evaluated by calculating an optical density of the coating. An optical density of a coating formed on each of the samples for evaluation was obtained by using an optical density meter (X-rite 361T (ortho filter) produced by Nihon Heihan Kizai Kabushiki Kaisha), irradiating a vertical transmission light flux to the coated film side of a sample and calculating by expressing a ratio with respect to a state without a coating film in log (logarithms). An optical density of 6.0 or more is an upper limit value of detection in the measurement. Evaluation reference is as below.
⊚: An optical density was 1.5 or more. (extremely preferable light-shielding characteristic)
◯: An optical density was 1.0 or more but less than 1.5 (preferable light-shielding characteristic)
X: Optical density was less than 1.0. (insufficient light-shielding characteristic)

### —Adhesiveness—

Adhesiveness of a coating film formed on each sample for evaluation to a surface of an object to be coated was evaluated by cutting the coating film in a grid pattern with a market-available cutter, putting thereon a cellophane tape (Cellulose tape produced by NICHIBAN Co., Ltd.), then taking off the tape, and visually observing a remaining state of the coating film. Evaluation reference is as below.
⊚: A coating film remained 100%. (extremely high adhesiveness)
◯: A coating film remained 75% or more and less than 100%. (high adhesiveness)
X: A coating film remained less than 75%. (insufficient adhesiveness)

### —Comprehensive Evaluation—

Glossiness, reflectance, a blackness degree, a light-shielding characteristic and adhesiveness as above were evaluated comprehensively. Evaluation reference is as below.
⊚: Evaluations on glossiness, reflectance, a blackness degree, a light-shielding characteristic and adhesiveness were all ⊚.
◯: At least one of the evaluations on glossiness, reflectance, a blackness degree, a light-shielding characteristic and adhesiveness was ◯, and there was no X.
X: At least one of the evaluations on glossiness, reflectance, a blackness degree, a light-shielding characteristic and adhesiveness was X.

### (3-3) Surface Properties

—Rz value, Rsm value, Rsk value, Rku value and Ra value—

Properties (Rz value, Rsm value, Rsk value, Rku value and Ra value) of a surface of a coating film formed on each sample for evaluation were measured by using a surface roughness measuring device (SURFCOM 480B produced by TOKYO SEIMITSU Co., Ltd.) by a method based on JIS B0601:2001. Evaluation references are as below.

### (Rz)

⊚: Rz was 10 μm or more. (extremely preferable)
◯: Rz was 7 μm or more but less than 10 μm. (preferable)
X: Rz was less than 7 μm. (defective)

### (Rsm)

⊚: Rsm was 120 μm or more. (extremely preferable)
◯: Rsm was 80 μm or more but less than 120 μm. (preferable)
X: Rsm was less than 80 μm. (defective)

### (Rsk)

⊚: Rsk was 0.2 or less. (extremely preferable)
◯: Rks exceeded 0.2 but 0.3 or less. (preferable)
X: Rsk exceeded 0.3. (defective)

### (Rku)

⊚: Rku was 3.3 or more. (extremely preferable)
◯: Rku was 3 or more but less than 3.3. (preferable)
X: Rku was less than 3. (defective)

### (Ra)

⊚: Ra was 1.5 μm or more. (extremely preferable)
◯: Ra was 0.5 μm or more but less than 1.5 μm. (preferable)
X: Ra was less than 0.5 μm. (defective)

TABLE 1

| | | | | | EXAMPLES | | | | | | | | | |
|---|---|---|---|---|---|---|---|---|---|---|---|---|---|---|
| | COMPONENTS | | | | 1 | 2 | 3 | 4 | 5 | 6 | 7 | 8 | 9 | 10 |
| LIQUID | A | A1 | | ACRYLIC | 60 | 60 | 60 | 60 | 60 | 60 | 60 | 60 | 60 | 60 |
| COMPO- | | | | RESIN | | | | | | | | | | |
| SITION | D | D1 | | ISOCY- | 40 | 40 | 40 | 40 | 40 | 40 | 40 | 40 | 40 | 40 |
| | | | | ANATE | | | | | | | | | | |
| | | | | COMPOUND | | | | | | | | | | |
| | B | B1 | B1a | CARBON | 20.0 | 19.0 | 15.0 | 13.0 | 12.0 | 15.0 | 15.0 | 15.0 | 15.0 | — |
| | | | | BLACK | | | | | | | | | | |
| | | | | (150 nm) | | | | | | | | | | |
| | | | B1b | TRANS- | — | — | — | — | — | — | — | — | — | 15.0 |
| | | | | PARENT | | | | | | | | | | |
| | | | | SILICA | | | | | | | | | | |
| | | | | (58 nm) | | | | | | | | | | |
| | | B2 | B2a | COMPOSITE | 35.0 | 36.0 | 40.0 | 42.0 | 43.0 | — | — | — | — | 40.0 |
| | | | | SILICA | | | | | | | | | | |
| | | | | (3 μm) | | | | | | | | | | |
| | | | B2b | BLACK | — | — | — | — | — | 40.0 | — | — | — | — |
| | | | | ACRYLIC | | | | | | | | | | |
| | | | | BEADS | | | | | | | | | | |
| | | | | (3 μm) | | | | | | | | | | |
| | | | B2c | TRANS- | — | — | — | — | — | — | — | 40.0 | — | — |
| | | | | PARENT | | | | | | | | | | |
| | | | | SILICA | | | | | | | | | | |
| | | | | (4.1 μm) | | | | | | | | | | |
| | | | B2d | TRANS- | — | — | — | — | — | — | — | — | 40.0 | — |
| | | | | PARENT | | | | | | | | | | |
| | | | | SILICA | | | | | | | | | | |
| | | | | (8 μm) | | | | | | | | | | |
| | | | B2e | TRANS- | — | — | — | — | — | — | 40.0 | — | — | — |
| | | | | PARENT | | | | | | | | | | |
| | | | | ACRYLIC | | | | | | | | | | |
| | | | | BEADS | | | | | | | | | | |
| | | | | (3 μm) | | | | | | | | | | |

| | | | | | | | | | | | | |
|---|---|---|---|---|---|---|---|---|---|---|---|---|
| | | ※B1:B2 = 1:• | 1.75 | 1.89 | 2.67 | 3.23 | 3.58 | 2.67 | 2.67 | 2.67 | 2.67 | 2.67 |
| | | (MASS RATIO) | | | | | | | | | | |
| | | ※(A + B + D):B = | 35.5 | 35.5 | 35.5 | 35.5 | 35.5 | 35.5 | 35.5 | 35.5 | 35.5 | 35.5 |
| | | 100:• (MASS RATIO) | | | | | | | | | | |
| EVALU- | LIQUID | COATING | ◯ | ◯ | ◯ | ◯ | ◯ | ◯ | ◯ | ◯ | ◯ | ◯ |
| ATION ON | | PERFORMANCE | | | | | | | | | | |
| CHARAC- | MEMBRANE | GLOSSINESS | ◯ | ◯ | ⊚ | ⊚ | ⊚ | ◯ | ◯ | ◯ | ⊚ | ◯ |
| TERISTICS | CHARAC- | (60° SPECULAR | | | | | | | | | | |
| | TERISTICS | GLOSSINESS) | | | | | | | | | | |
| | | GLOSSINESS | ◯ | ◯ | ⊚ | ⊚ | ⊚ | ◯ | ◯ | ⊚ | ⊚ | ◯ |
| | | (85° SPECULAR | | | | | | | | | | |
| | | GLOSSINESS) | | | | | | | | | | |
| | | COMPREHENSIVE | ◯ | ◯ | ⊚ | ⊚ | ⊚ | ◯ | ◯ | ◯ | ⊚ | ◯ |
| | | GLOSSINESS | | | | | | | | | | |
| | | REFLECTANCE | ◯ | ◯ | ⊚ | ⊚ | ⊚ | ◯ | ◯ | ◯ | ◯ | ◯ |
| | | (ANTIREFLECTION | | | | | | | | | | |
| | | CHARACTERISTIC) | | | | | | | | | | |
| | | L VALUE (L*VALUE | X | ◯ | ⊚ | ⊚ | ⊚ | X | X | ◯ | X | ◯ |
| | | IN CIELAB COLOR | | | | | | | | | | |
| | | SPACE SYSTEM) | | | | | | | | | | |
| | | LIGHT-SHIELDING | ⊚ | ⊚ | ⊚ | ◯ | X | ◯ | X | ◯ | X | ◯ |
| | | CHARACTERISTIC | | | | | | | | | | |
| | | ADHESIVENESS | ⊚ | ⊚ | ⊚ | ◯ | X | ⊚ | ⊚ | ⊚ | X | ⊚ |
| | | ※COMPREHENSIVE | X | ◯ | ⊚ | ◯ | X | X | X | ◯ | X | ◯ |
| | | EVALUATION | | | | | | | | | | |
| | | ON MEMBRANE | | | | | | | | | | |
| | | CHARACTERISTICS | | | | | | | | | | |
| | MEMBRANE | Rz | X | ◯ | ⊚ | ⊚ | ⊚ | ◯ | ◯ | ◯ | ◯ | ◯ |
| | PROPERTY | Rsm | ◯ | ◯ | ⊚ | ⊚ | ⊚ | ◯ | ◯ | ◯ | ◯ | ◯ |
| | | Rsk | X | ◯ | ⊚ | ◯ | ◯ | ◯ | ◯ | ◯ | ◯ | ◯ |
| | | Rku | ⊚ | ⊚ | ⊚ | ◯ | ◯ | ◯ | ◯ | ◯ | ◯ | ◯ |
| | | Ra | ◯ | ◯ | ⊚ | ⊚ | ⊚ | ◯ | ◯ | ◯ | ◯ | ◯ |

| | | | | EXAMPLES | | | | | | | |
|---|---|---|---|---|---|---|---|---|---|---|---|
| | COMPONENTS | | | 11 | 12 | 13 | 14 | 3 | 15 | 16 | 17 |
| LIQUID | A | A1 | ACRYLIC | 60 | 60 | 60 | 60 | 60 | 60 | 60 | 60 |
| COMPO- | | | RESIN | | | | | | | | |
| SITION | D | D1 | ISOCY- | 40 | 40 | 40 | 40 | 40 | 40 | 40 | 40 |
| | | | ANATE | | | | | | | | |
| | | | COMPOUND | | | | | | | | |

| | | | | | | | | | | | |
|---|---|---|---|---|---|---|---|---|---|---|---|
| B | B1 | B1a | CARBON | 15.0 | — | 5.0 | 10.0 | 15.0 | 25.0 | 35.0 | 45.0 |
| | | | BLACK | | | | | | | | |
| | | | (150 nm) | | | | | | | | |
| | | B1b | TRANS- | 40.0 | 15.0 | — | — | — | | — | — |
| | | | PARENT | | | | | | | | |
| | | | SILICA | | | | | | | | |
| | | | (58 nm) | | | | | | | | |
| | B2 | B2a | COMPOSITE | — | — | 16.0 | 19.0 | 40.0 | 62.0 | 80.0 | 120.0 |
| | | | SILICA | | | | | | | | |
| | | | (3 μm) | | | | | | | | |
| | | B2b | BLACK | — | 40.0 | — | — | — | — | — | — |
| | | | ACRYLIC | | | | | | | | |
| | | | BEADS | | | | | | | | |
| | | | (3 μm) | | | | | | | | |
| | | B2c | TRANS- | — | — | — | — | — | — | — | — |
| | | | PARENT | | | | | | | | |
| | | | SILICA | | | | | | | | |
| | | | (4.1 μm) | | | | | | | | |
| | | B2d | TRANS- | — | — | — | — | — | — | — | — |
| | | | PARENT | | | | | | | | |
| | | | SILICA | | | | | | | | |
| | | | (8 μm) | | | | | | | | |
| | | B2e | TRANS- | — | — | — | — | — | — | — | — |
| | | | PARENT | | | | | | | | |
| | | | ACRYLIC | | | | | | | | |
| | | | BEADS | | | | | | | | |
| | | | (3 μm) | | | | | | | | |

| | | | | | | | | | | |
|---|---|---|---|---|---|---|---|---|---|---|
| | | ※B1:B2 = 1:• | 2.67 | 2.67 | 3.20 | 1.90 | 2.67 | 2.48 | 2.29 | 2.67 |
| | | (MASS RATIO) | | | | | | | | |
| | | ※(A + B + D):B = | 35.5 | 35.5 | 17.4 | 22.5 | 35.5 | 46.5 | 53.5 | 62.3 |
| | | 100:• (MASS RATIO) | | | | | | | | |
| EVALU- | LIQUID | COATING | ◯ | ◯ | ◯ | ◯ | ◯ | ◯ | ◯ | ◯ |
| ATION ON | | PERFORMANCE | | | | | | | | |
| CHARAC- | MEMBRANE | GLOSSINESS | X | ◯ | X | ◯ | ⊚ | ◯ | ◯ | ◯ |
| TERISTICS | CHARAC- | (60° SPECULAR | | | | | | | | |
| | TERISTICS | GLOSSINESS) | | | | | | | | |
| | | GLOSSINESS | X | ◯ | X | ◯ | ⊚ | ⊚ | ⊚ | ◯ |
| | | (85° SPECULAR | | | | | | | | |
| | | GLOSSINESS) | | | | | | | | |
| | | COMPREHENSIVE | X | ◯ | X | ◯ | ⊚ | ◯ | ◯ | ◯ |
| | | GLOSSINESS | | | | | | | | |
| | | REFLECTANCE | X | ◯ | X | ◯ | ⊚ | ◯ | ◯ | ◯ |
| | | (ANTIREFLECTION | | | | | | | | |
| | | CHARACTERISTIC) | | | | | | | | |
| | | L VALUE (L*VALUE | X | X | X | ◯ | ⊚ | ◯ | ◯ | ◯ |
| | | IN CIELAB COLOR | | | | | | | | |
| | | SPACE SYSTEM) | | | | | | | | |
| | | LIGHT-SHIELDING | ◯ | X | X | ◯ | ⊚ | ◯ | ◯ | ◯ |
| | | CHARACTERISTIC | | | | | | | | |
| | | ADHESIVENESS | X | ◯ | ⊚ | ⊚ | ⊚ | ◯ | ◯ | X |
| | | ※COMPREHENSIVE | X | X | X | ◯ | ⊚ | ◯ | ◯ | X |
| | | EVALUATION | | | | | | | | |
| | | ON MEMBRANE | | | | | | | | |
| | | CHARACTERISTICS | | | | | | | | |
| | MEMBRANE | Rz | X | ◯ | X | ◯ | ⊚ | ⊚ | ⊚ | ⊚ |
| | PROPERTY | Rsm | X | X | X | ◯ | ⊚ | ⊚ | ⊚ | ⊚ |
| | | Rsk | X | X | X | ◯ | ⊚ | ⊚ | ◯ | ◯ |
| | | Rku | X | X | X | ◯ | ⊚ | ⊚ | ◯ | ◯ |
| | | Ra | X | ◯ | X | ◯ | ⊚ | ⊚ | ⊚ | ⊚ |

### 4. Consideration

As shown in Table 1, when a liquid for forming a membrane did not comprise as (B) one or more of (B1) and (B2) (Examples 6, 7, 9, 11 and 12), at least one of the membrane characteristics of glossiness, reflectance, an L value, a light-shielding characteristic and adhesiveness was not satisfied. On the other hand, even both of (B1) and (B2) were contained as (B) in the liquid (Examples 1 to 5, 8 and 10), when a mass ratio of (B2) with respect to (B1):1 was 1.75 or less (Example 1) or 3.58 or more (Example 5), one or more of an L value and adhesiveness of the membrane characteristics was not satisfied. Even if both of (B1) and (B2) were contained and a mass ratio of (B2) with respect to (B1):1 was in a proper range (exceeding 1.75 and less than 3.58) (Examples 2 to 4 and 13 to 17), when a content (total amount) of (B) in 100% by mass of a total solid content was less than 20% by mass (Example 13) or exceeding 60% by mass (Example 17), one or more of glossiness, reflectance, an L value, a light-shielding characteristic and adhesiveness of the membrane characteristics was not satisfied.

On the other hand, when a mass ratio range of (B2) with respect to (B1):1 exceeded 1.75 and less than 3.58 and a total content of (B) with respect to a total solid amount of 100% by mass in a composition was 20% by mass or more and 60% by mass or less (Examples 2 to 4, 8, 10 and 14 to 16), all of the coating performance of the liquid, membrane characteristics and membrane properties were satisfied.

### DESCRIPTION OF NUMERICAL NOTATIONS

1 . . . camera module
2 . . . lens unit
   41, 43, 45, 47, 49 . . . lens
   61, 63, 65 . . . spacer (ring-shaped light-shielding member)
      61a, 63a, 65a . . . spacer substrate
      7 . . . antireflection film
   8 . . . holder
9 . . . image pickup element

1. A lens unit, configured by providing a group of lenses, which is composed of a plurality of lenses stacked in the direction of an optical axis, in a holder,
wherein
a ring-shaped light-shielding member is provided between at least one pair of lenses;
the light-shielding member has an antireflection film at least on an end surface;
the antireflection film is configured by a membrane having a thickness of greater than or equal to 2 μm and less than or equal to 40 μm formed from a liquid composition by spray coating;
the liquid composition comprises at least (A), (B) and (C);
(B) is contained in an amount of 20% or more by mass and 60% or less by mass in a total amount of 100% by mass of all solid content in the composition;
(B) comprises (B1) and (B2) in an amount of 90% or more by mass and a mass ratio of (B2) with respect to (B1): is greater than or equal to 1.8 and less than or equal to 3.3;
(A) is a resin component;
(B) is unevenness forming particles;
(B1) is inorganic-type small particles having a particle diameter of greater than or equal to 0.05 μm and less than or equal to 0.4 μm;
(B2) is inorganic-type large particles having a particle diameter of greater than or equal to 2 μm and less than or equal to 6 μm; and
(C) is a diluent solvent.

2. The lens unit according to claim 1, wherein (B2) comprises silica.

3. The lens unit according to claim 2, wherein silica includes complex silica colored black with a colorant.

4. The lens unit according to claim 1, wherein (B1) comprises carbon black.

5. The lens unit according to claim 1, wherein an outermost surface of a plane formed with a membrane has glossiness of less than 1% against an incident light with an incident angle of 60°, glossiness of less than 5% against an incident light with an incident angle of 85°, reflectance of 4% or less against a light having a wavelength of 550 nm, an L value in CIELAB color space system by SCE method of less than or equal to 22 and an optical density of greater than or equal to 1.0.

6. The lens unit according to claim 5, wherein, on an outermost surface of a plane formed with a membrane, a maximum height Rz based on JIS B0601:2001 is greater than or equal to 7 μm, an average length Rsm of contour curve elements is greater than or equal to 80 μm, a skewness Rsk of a contour curve is less than or equal to 0.3, and Kurtosis Rku of a contour curve is greater than or equal to 3.

7. A camera module, comprising a lens unit according to claim 1 and an image pickup element for picking up an image of a subject through the lend unit.

8. An antireflection film, formed on components of a lens unit, configured by a membrane having a thickness of greater than or equal to 2 μm and less than or equal to 40 μm formed from a liquid composition by spray coating:
wherein
the liquid composition comprises at least (A), (B) and (C);
(B) is contained in an amount of 20% or more by mass and 60% or less by mass in a total amount of 100% by mass of all solid content in the composition;
(B) comprises (B1) and (B2) in an amount of 90% or more by mass, and a mass ratio of (B2) with respect to (B1): is greater than or equal to 1.8 and less than or equal to 3.3;
(A) is a resin component;
(B) is unevenness forming particles;
(B1) is inorganic-type small particles having a particle diameter of greater than or equal to 0.05 μm and less than or equal to 0.4 μm;
(B2) is inorganic-type large particles having a particle diameter of greater than or equal to 2 μm and less than or equal to 6 μm; and
(C) is a diluent solvent.

9. The lens unit according to claim 2, wherein (B1) comprises carbon black.

10. The lens unit according to claim 3, wherein (B1) comprises carbon black.

11. The lens unit according to claim 2, wherein an outermost surface of a plane formed with a membrane has glossiness of less than 1% against an incident light with an incident angle of 60°, glossiness of less than 5% against an incident light with an incident angle of 85°, reflectance of 4% or less against a light having a wavelength of 550 nm, an L value in CIELAB color space system by SCE method of less than or equal to 22 and an optical density of greater than or equal to 1.0 or more.

12. The lens unit according to claim 3, wherein an outermost surface of a plane formed with a membrane has glossiness of less than 1% against an incident light with an incident angle of 60°, glossiness of less than 5% against an incident light with an incident angle of 85°, reflectance of 4% or less against a light having a wavelength of 550 nm, an L value in CIELAB color space system by SCE method of less than or equal to 22 and an optical density of greater than or equal to 1.0.

13. The lens unit according to claim 4, wherein an outermost surface of a plane formed with a membrane has glossiness of less than 1% against an incident light with an incident angle of 60°, glossiness of less than 5% against an incident light with an incident angle of 85°, reflectance of 4% or less against a light having a wavelength of 550 nm, an L value in CIELAB color space system by SCE method of less than or equal to 22 and an optical density of greater than or equal to 1.0.

14. The lens unit according to claim 9, wherein an outermost surface of a plane formed with a membrane has glossiness of less than 1% against an incident light with an incident angle of 60°, glossiness of less than 5% against an incident light with an incident angle of 85°, reflectance of 4% or less against a light having a wavelength of 550 nm, an L value in CIELAB color space system by SCE method of less than or equal to 22 and an optical density of greater than or equal to 1.0.

15. The lens unit according to claim 10, wherein an outermost surface of a plane formed with a membrane has glossiness of less than 1% against an incident light with an incident angle of 60°, glossiness of less than 5% against an incident light with an incident angle of 85°, reflectance of 4% or less against a light having a wavelength of 550 nm, an L value in CIELAB color space system by SCE method of less than or equal to 22 and an optical density of greater than or equal to 1.0.

16. The lens unit according to claim 11, wherein, on an outermost surface of a plane formed with a membrane, a maximum height Rz based on JIS B0601:2001 is greater than or equal to 7 μm, an average length Rsm of contour curve elements is greater than or equal to 80 μm, a skewness Rsk of a contour curve is less than or equal to 0.3, and Kurtosis Rku of a contour curve is greater than or equal to 3.

17. The lens unit according to claim 12, wherein, on an outermost surface of a plane formed with a membrane, a maximum height Rz based on JIS B0601:2001 is greater than or equal to 7 μm, an average length Rsm of contour curve elements is greater than or equal to 80 μm, a skewness Rsk of a contour curve is less than or equal to 0.3, and Kurtosis Rku of a contour curve is greater than or equal to 3.

18. The lens unit according to claim 13, wherein, on an outermost surface of a plane formed with a membrane, a maximum height Rz based on JIS B0601:2001 is greater than or equal to 7 μm, an average length Rsm of contour curve elements is greater than or equal to 80 μm, a skewness Rsk of a contour curve is less than or equal to 0.3, and Kurtosis Rku of a contour curve is greater than or equal to 3.

19. The lens unit according to claim 14, wherein, on an outermost surface of a plane formed with a membrane, a maximum height Rz based on JIS B0601:2001 is greater than or equal to 7 μm, an average length Rsm of contour curve elements is greater than or equal to 80 μm, a skewness Rsk of a contour curve is less than or equal to 0.3, and Kurtosis Rku of a contour curve is greater than or equal to 3.

20. The lens unit according to claim 15, wherein, on an outermost surface of a plane formed with a membrane, a maximum height Rz based on JIS B0601:2001 is greater than or equal to 7 μm, an average length Rsm of contour curve elements is greater than or equal to 80 μm, a skewness Rsk of a contour curve is less than or equal to 0.3, and Kurtosis Rku of a contour curve is greater than or equal to 3.
